(19) United States
(12) Patent Application Publication
(10) Pub. No.: US 2022/0142035 A1
(43) Pub. Date: May 12, 2022

(54) COLLISION AVOIDANCE OF AN AUTONOMOUS AGRICULTURAL MACHINE

(71) Applicant: ZF Friedrichshafen AG, Friedrichshafen (DE)

(72) Inventors: Michael Amann, Tettnang (DE); Marcus Hiemer, Meckenbeuren (DE)

(21) Appl. No.: 17/431,180

(22) PCT Filed: Feb. 10, 2020
(86) PCT No.: PCT/EP2020/053244

§ 371 Date: Aug. 16, 2021

(30) Foreign Application Priority Data
Feb. 18, 2019 (DE) 10 2019 202 107.7

(51) Int. Cl. A01B 69/04; G05D 1/02

(52) U.S. Cl. CPC A01B 69/008; G05D 1/0214; G05D 2201/0201; G05D 1/0238; G05D 1/0223

(57) ABSTRACT

A method for controlling an autonomous agricultural machine, which is configured to not traverse a predetermined geographic boundary, includes determining a trajectory of a moving object in surroundings of the agricultural machine. The method further includes determining a trajectory of the agricultural machine, determining a predicted collision point between the agricultural machine and the moving object based on the trajectories, and adapting a planned trajectory of the agricultural machine such that an adapted collision point lies on another side of the boundary relative to the agricultural machine.

### CROSS REFERENCE TO RELATED APPLICATIONS

This application is a U.S. National Phase application under 35 U.S.C. § 371 of International Application No. PCT/EP2020/053244, filed on Feb. 10, 2020, and claims benefit to German Patent Application No. DE 10 2019 202 107.7, filed on Feb. 18, 2021. The International Application was published in German on Aug. 27, 2020 as WO 2020/169373 A1 under PCT Article 21(2).

### FIELD

The present disclosure relates to the controlling of an autonomous agricultural machine. In particular, the disclosure relates to the avoidance of a collision between the agricultural machine and a moving object.

### BACKGROUND

An agricultural machine is configured to perform an agricultural task. For this purpose, the agricultural machine can be moving autonomously and, for example, move along a predetermined trajectory. The agricultural machine may comprise, for example, a combine harvester which is configured to harvest a predetermined field.

A collision of the agricultural machine with an immovable object can usually be easily avoided by detecting the object and controlling the agricultural machine to drive around the object or to stop in front of the object. It can be much more difficult to avoid collision with a moving object. In particular, determining an evasive trajectory on which a collision with the object can be expected to be avoided can be difficult. In practice, an agricultural machine is therefore often only slowed or stopped in response to an imminent collision with a moving object.

Although a system that is configured to avoid collisions of the agricultural machine with a moving object can be retrofitted, it usually comprises dedicated devices and components that are hardly or not at all integrated with existing components of the agricultural machine. Such a system can be costly and, in some circumstances, integrating it into the agricultural machine's control system is difficult.

### SUMMARY

In an embodiment, the present disclosure provides a method for controlling an autonomous agricultural machine, which is configured to not traverse a predetermined geographic boundary. The method includes determining a trajectory of a moving object in surroundings of the agricultural machine, determining a trajectory of the agricultural machine, determining a predicted collision point between the agricultural machine and the moving object based on the trajectories, and adapting a planned trajectory of the agricultural machine such that an adapted collision point lies on another side of the boundary relative to the agricultural machine.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 an exemplary system; and

FIG. 2 a flow chart of an exemplary method.

### DETAILED DESCRIPTION

The present disclosure specifies an improved technique for avoiding the collision of an agricultural machine with a moving object in its vicinity.

An autonomously operating agricultural machine is usually configured to not traverse a predetermined boundary. For this purpose, a technique may be used which is called geofencing and ensures that the agricultural machine does not cross or breach a predetermined geographic boundary. If the agricultural machine approaches the boundary, it is usually stopped or its course is changed appropriately. Such systems are already well tested and can be operated with a high level of safety.

A method for controlling the agricultural machine comprises steps of determining a trajectory of a moving object in the surroundings of the agricultural machine; determining a trajectory of the agricultural machine; determining a predicted collision point between the agricultural machine and the moving object on the basis of the trajectories; and adapting a planned trajectory of the agricultural machine such that an adapted collision point lies on the other side of the boundary relative to the agricultural machine.

It has been identified that the avoidance of collisions of the agricultural machine with a moving object can be integrated with geofencing technology which ensures that the agricultural machine adheres to the boundary. The determination of an evasive trajectory or the control of the agricultural machine can thus take place simply by means of known technologies or components. Since the agricultural machine cannot traverse the geographic boundary, a collision with the moving object on the other side of the boundary is not possible. Consequently, the collision can also be avoided by preventing the boundary from being crossed. The intervention into the trajectory of the agricultural machine may be subtle so that a main load of the control system of the agricultural machine may lie with geofencing. The collision avoidance system may therefore be simple in design and conflicting control interventions by the geofencing and the collision avoidance system need not be feared.

The trajectory of the agricultural machine can be determined on the basis of the determination of a series of positions of the agricultural machine. Alternatively, the trajectory may also be acquired by a control device. In yet a further embodiment, a planned trajectory along which the agricultural machine should still drive is determined. The planned trajectory can also be integrated with or supplemented by a traversed trajectory.

It is preferred that the boundary encloses a predetermined area. In a first variant, the agricultural machine is located within the area and the trajectory is adapted such that an adapted collision point is located outside the area. The area can relate, for example, to one or more contiguous fields that are to be worked by the agricultural machine or a device connected thereto.

In a second variant, the agricultural machine is located outside the area and the trajectory is adapted such that an adapted collision point is located within the area. This technology can be used to keep the agricultural machine away from an area, for example from a field other than a field to be worked, a residential area or a safety hazard, such as a body of water or a slope.

The two variants can also be integrated with one another, wherein a first area comprises a second area at least in part, wherein the agricultural machine must be located in the first area but must not be located in the second area. Optionally, several second areas in which the agricultural machine must not enter are also provided.

In one embodiment, a geographic position of the agricultural machine is determined and compared with geographic coordinates of the boundary. The geofencing function may thus be performed without physically marking the boundary. The position of the agricultural machine can in particular be determined by means of a GNSS (global navigation satellite system); for this purpose, a receiver for satellite signals can be provided on the agricultural machine. The boundary can also be detected optically, for example, by means of a camera for instance. The boundary may also be marked, for example by means of a series of reflectors which can be detected by means of a suitable scanning device on board the agricultural machine.

The agricultural machine is preferably configured to autonomously carry out an agricultural function. To this end, the agricultural machine can move toward a number of predetermined points, for example fruit trees in a meadow, or move away from a predetermined region such that a maximum distance is maintained between tracks driven. In particular, the agricultural machine may be configured to travel in a meandering manner over the region, for example in order to work the entire surface by means of a device carried along.

The trajectory of the agricultural machine may be determined while disregarding a road in the surroundings. This can include both determining the trajectory of the agricultural machine and adapting the planned trajectory. In other words, the agricultural machine is preferably an off-road vehicle which is configured to be used outside a road network. Of course, the agricultural machine may still use a road, for example to drive from one roadless area of application to another.

Adapting the trajectory may include adapting a speed of the agricultural machine. The agricultural machine can thus maintain its original course. Consequently, the working of a surface or of points in an area need hardly be interrupted. Adapting the trajectory may include adapting a direction of travel of the agricultural machine. Both variants can be combined with one another.

The predetermined geographic boundary can be regarded as a further object, wherein the agricultural machine is controlled to avoid a collision with the object and the further object. The collision avoidance system and the geofencing may thus be integrated with one another in a further improved manner. One realization can repeatedly take advantage of a larger number of components. The implementation effort for both solutions can be reduced overall.

An autonomous agricultural machine is configured to not traverse a predetermined geographic boundary. A device for controlling the autonomous agricultural machine comprises a scanning device for scanning the surroundings of the agricultural machine; and a processing device. The processing device is configured to determine a trajectory of a moving object in the surroundings of the agricultural machine; to determine a trajectory of the agricultural machine; to determine a predicted collision point between the agricultural machine and the moving object on the basis of the trajectories; and to adapt a planned trajectory of the agricultural machine such that an adapted collision point lies on the other side of the boundary relative to the agricultural machine.

The device can easily be retrofitted to an existing agricultural machine. In particular, a device may be used which is already attached to the agricultural machine and which is configured, for example, to determine a planned trajectory or to control the agricultural machine along the planned trajectory.

The processing device may be configured to carry out all or part of a method described herein. For this purpose, the processing device may comprise a programmable microcomputer or microcontroller, and the method may take the form of a computer program product comprising program code means. The computer program product may also be saved on a computer-readable data carrier. Features or advantages of the method may be transmitted to the device or vice versa.

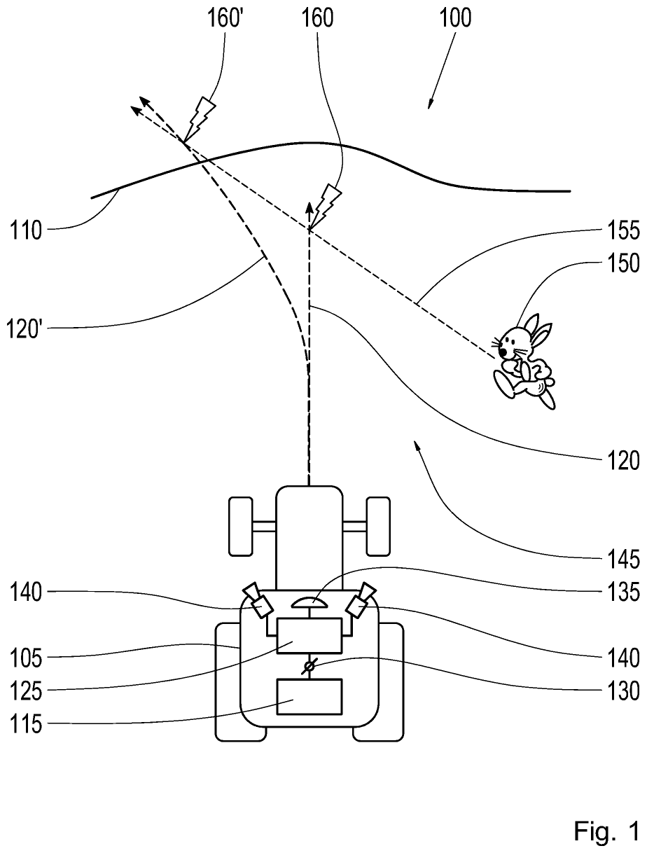

FIG. 1 shows a system 100 comprising an agricultural machine 105 which is configured to not traverse a predetermined geographic boundary 110. The agricultural machine 105 is preferably configured to not breach the boundary 110, that is to say to not extend beyond the boundary 110 with any of its contours. Optionally, maintaining a predetermined safety distance between the agricultural machine 105 and the boundary 110 may also be controlled.

The agricultural machine 105 comprises, for example, a tractor or an agricultural or forestry machine, which is further preferably configured to treat plants or animals on agricultural land. The agricultural machine 105 is preferably configured to be used on ground without roads or paths. More preferably, the agricultural machine 105 comprises a control system 115 for guiding it along a planned trajectory 120. Optionally, the control system 115 is also configured to plan or determine the trajectory 120.

Preferably, a further control system 125 is provided, which can be integrated with the control system 115 or connected to it by means of an interface 130. The further control system 125 is preferably configured to ensure that the agricultural machine 105 does not traverse or breach the predetermined geographic boundary 110. For this purpose, the further control system 125 may be configured to determine a position of the agricultural machine 105 and to compare it with a specification of the course of the boundary 110. Usually, the boundary 110 encloses a predetermined area in which the agricultural machine 105 can operate autonomously and the further control system 125 ensures that the agricultural machine 105 remains within the area. If the agricultural machine 105 moves closer than predetermined to the boundary 110, the further control system 125 can influence the control system of the agricultural machine 105 and ensure the integrity of the boundary 110 by slowing or stopping or changing course, for example.

A positioning device 135 may be provided for determining the position of the agricultural machine 105. One or more further scanning devices 140 may also be provided, for example, a GNSS receiver, a camera, a radar sensor, a LiDAR sensor, an inertial system or another sensor. A scanning device 140 is configured to scan the surroundings 145 of the agricultural machine 105.

If a moving object 150 stops in the region of the agricultural machine 105, it can be detected by means of the scanning device 140. For example, a trajectory 155 of the object 150 may be determined, for example by means of extrapolation, on the basis of a plurality of staggered detections. The planned trajectory 120 of the agricultural machine 105 is known or can be determined by the control system 115 or on the basis of observations by means of the positioning device 135 and/or a scanning device 140. On the basis of trajectories 120 and 155, it can be determined whether there is a collision point 160, i.e., whether a collision is to be expected between the object 150 and the agricultural machine 105. An imminent collision can be determined if the collision point 160 falls below a predetermined maximum distance from the agricultural machine 105.

In order to avoid the collision, it is proposed that the planned trajectory 120 of the agricultural machine 105 be modified to an adapted trajectory 120′. The modification can be achieved by increasing or decreasing a driving speed of the agricultural machine 105 and/or by changing a driving direction. The modified trajectory 120′ modifies the collision point 160 to an adapted collision point 160′. In this case, the modification is to be made such that the changed collision point 160′ is on the other side of the boundary 110 relative to the agricultural machine 105. The scanning of the environment 145, the determination of the collision point 160 and the modification of the trajectory 120 are preferably carried out by means of the further control system 125.

Since the agricultural machine 105 cannot reach the adapted collision point 160′ since it is restricted to an operation on the other side of the boundary 110. In this way, a collision with the moving object 150 can be ruled out. Advantageously, the collision is avoided in a controlled manner in that the agricultural machine 105 does not drive an arbitrary evasive maneuver. The modification of the trajectory 120 and the maintenance of the integrity of the boundary 110 can be further advantageously controlled by the same control system 115 so that an organic and consistent influencing of the movement of the agricultural machine 105 can result.

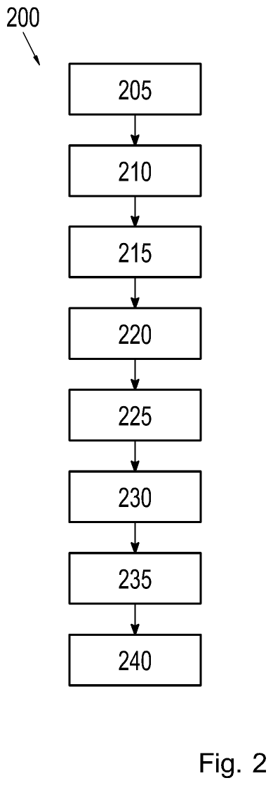

FIG. 2 shows a flow chart of a method 200 which can be carried out in particular by means of a system 100 according to FIG. 1. Parts of the method 200 can be performed, in particular, by means of the further control system 125.

In a step 205, the surroundings 145 of the agricultural machine 105 are preferably scanned. On the basis of data thereby detected, the moving object 150 can be detected in a step 210. The fact that the object 150 is moving can be determined on the basis of a plurality of staggered scans, or one of the scanning devices 140 can be configured to determine a speed of the object 150. Since the scanning device 140 is usually attached to the agricultural machine 105, a specific movement of the object 150 about the intrinsic movement of the agricultural machine 105 can be compensated for. If the object 150 does not move, a collision with it can be prevented in a manner other than that described here.

In a step 215, the trajectory 155 of the object 150 can be determined. For this purpose, a previous trajectory 155 of the object 150 is preferably detected and extrapolated, i.e., extrapolated toward the future using a temporal observation limit. Different methods may be used for this purpose, one of which can optionally be selected as a function of the object 150. Thus, a first extrapolation method may be used for a rabbit or a second extrapolation method may be used for another agricultural machine 105.

In a step 220, the trajectory 120 of the agricultural machine 105 can be determined. The determination may be determined on the basis of an observed intrinsic movement of the agricultural machine 105, analogously to the determination of the trajectory 155 of the object 150. A previous trajectory 20 may then be extrapolated in a predetermined manner. However, it is preferred that an upcoming part of the trajectory 120 is determined as a planned or intended trajectory 120. This information may be provided in particular by the control system 115.

On the basis of the predicted sections of the trajectories 120 and 155, it can be determined in a step 225 whether a collision of the agricultural machine 105 with the object 150 is imminent, and preferably where the collision point 160 is located at which the collision is predicted to take place. If the collision point 160 is located further than a predetermined distance from the agricultural machine 105, the collision can be classified as unlikely. In this case, the method 200 can be run through again until the collision point 160 is close enough.

In a step 230, it can be determined on which side of the boundary 110 the determined collision point 160 is located relative to the agricultural machine 105. If the collision point 160 and the current position of the agricultural machine 105 are on different sides of the boundary 110, a collision is unlikely to be expected.

However, if both are on the same side of the boundary 110, the planned trajectory 120 can be modified to the adapted trajectory 120′ of the agricultural machine 105 in a step 235 such that the collision point 160 transitions into the adapted collision point 160′ which is located on the other side of the boundary 110. For this purpose, a position can be determined which lies on the predicted trajectory 155 of the object 150, is located on the other side of the boundary 110, and can be reached by the agricultural machine 105 at a selected speed, in particular its current speed. This position may be assumed as the target position of the agricultural machine 105. Thereafter, the agricultural machine is preferably controlled to this position, wherein a customary avoidance of a collision with an immovable object can be carried out.

In a step 240, the collision can actively be avoided if the agricultural machine 105 is prevented from reaching the adapted collision point 160′ lying on the other side of the boundary 110. This step is usually carried out by a device other than the further control system 125 so that it cannot be considered as part of the method 200. In this step, a speed and/or a direction of the agricultural machine 105 can be influenced such that the agricultural machine 105 does not breach the boundary 110.

As a result, a new planned trajectory or a new position to head for can be determined, wherein the determination can take place in such a way that a task to be carried out originally can still be performed by the agricultural machine 105. For example, the task may include moving toward a predetermined point or traversing an area. The agricultural machine 105 can determine a new trajectory 120 and move autonomously again along this trajectory 120.

The method 200 may return to the beginning and be run through again.

If the object 150 followed a trajectory other than the determined trajectory 155, the method 200 can react thereto in the manner described and avoid an imminent collision, optionally by modifying the trajectory 120 again.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

100 System
105 Agricultural machine
110 Boundary
115 Control system
120 Planned trajectory of the agricultural machine
120′ Adapted trajectory of the agricultural machine
125 Further control system
130 Interface
135 Positioning device
140 Scanning device
145 Surroundings
150 Moving object
155 Trajectory of the object
160 Collision point
160′ Adapted collision point
200 Method
205 Scan surroundings
210 Detect object
215 Determine trajectory of object
220 Determine intrinsic trajectory
225 Collision imminent?
230 Collision point on this side of boundary?
235 Adapt intrinsic trajectory
240 Prevent boundary crossing

1. A method for controlling an autonomous agricultural machine, which is configured to not traverse a predetermined geographic boundary, the method comprising:
determining a trajectory of a moving object in surroundings of the agricultural machine;
determining a trajectory of the agricultural machine;
determining a predicted collision point between the agricultural machine and the moving object based on the trajectories; and
adapting a planned trajectory of the agricultural machine such that an adapted collision point lies on another side of the boundary relative to the agricultural machine.

2. The method according to claim 1, wherein the boundary encloses a predetermined area, the agricultural machine is located within the area, and the trajectory is adapted such that the adapted collision point is located outside the area.

3. The method according to claim 1, wherein the boundary encloses a predetermined area, the agricultural machine is located outside the area, and the trajectory is adapted such that the adapted collision point is located within the area.

4. The method according to claim 1, further comprising determining a geographic position of the agricultural machine and comparing the determined geographic position with geographic coordinates of the boundary.

5. The method according to claim 1, wherein the agricultural machine is configured to autonomously carry out an agricultural function.

6. The method according to claim 1, wherein the trajectory of the agricultural machine is determined while disregarding a road in the surroundings.

7. The method according to claim 1, wherein adapting the trajectory includes adapting the speed of the agricultural machine.

8. The method according to claim 1, wherein adapting the trajectory includes adapting the direction of travel of the agricultural machine.

9. The method according to claim 1, wherein the predetermined geographic boundary is regarded as a further object, and the agricultural machine is controlled to avoid a collision with the object and the further object.

10. A device for controlling an autonomous agricultural machine, which is configured to not traverse a predetermined geographic boundary, the device comprising:
a scanning device configured to scan the surroundings of the agricultural machine; and
a processing device configured to:
determine a trajectory of a moving object in the surroundings of the agricultural machine;
determine a trajectory of the agricultural machine;
determine a predicted collision point between the agricultural machine and the moving object based on the trajectories; and
adapt a planned trajectory of the agricultural machine such that an adapted collision point lies on another side of the boundary relative to the agricultural machine.
